(19) United States
(12) Patent Application Publication
(10) Pub. No.: US 2003/0046692 A1
(43) Pub. Date: Mar. 6, 2003

(54) CONTENTION-SOLVING METHOD FOR A BIDIRECTIONAL T.V. DISTRIBUTION SYSTEM

(76) Inventors: GUILLENE TEBOUL, FONTENAY-SOUS-BOIS (FR); RAPHAEL ALIMI, PARIS (FR)

Correspondence Address: MICHAEL E BELK, U S PHILIPS CORPORATION, 580 WHITE PLAINS ROAD, TARRYTOWN, NY, 10591

(21) Appl. No.: 09/143,839

(22) Filed: Aug. 31, 1998

(30) Foreign Application Priority Data
Sep. 3, 1997 (EP) 97402049.7

(51) Int. Cl. G06F 3/00

(52) U.S. Cl. 725/39

(57) ABSTRACT

The invention relates to a TV distribution system which comprises a network head-end, user stations and an upstream channel from the user stations to the network head-end. Each upstream channel transports an upstream frame divided into time slot regions, each region corresponding to a different type of access for the stations. Each frame can notably contain a contention based region to which all the stations have free access.

It is an object of the invention to propose a method of solving collisions which may happen during the access to the contention based region by said stations. In accordance with the invention, when one or various contentions have been detected, the use of the contention based region of a following upstream channel is reserved to the solution of these contentions. The size of this contention based region is determined by the number of contentions to be solved. Only the stations that are involved in one of said contentions are authorized to use this contention based region for retransmitting the data about which there has been contention.

### DESCRIPTION

The invention relates to a bidirectional TV distribution system of the DAVIC type comprising at least:

a network head-end serving a plurality of user stations,

at least an upstream channel for transporting frames called upstream frames from at least certain user stations to the network head-end, said upstream frames, divided into time slots, being suitable for containing time slots called contention time slots which are accessible to any user station in the contention mode for transmitting data to said network head-end,

contention detection means for detecting contentions which are likely to occur during such an access,

contention solving means for solving said contentions.

The invention also relates to a contention solving method, a network head-end, and a user station which are intended to be used in such a cable TV distribution system.

Recommendation ETS300800 by the ETSI (which takes up the DAVIC standard) describes the specifications relating to the upstream path in interactive systems of TV distribution by cable networks. The Recommendation notably states in paragraph 5.5.2.4 that the upstream frames have various regions of variable size (that is to say, that said regions have a variable number of time slots) which regions correspond to various types of access to the frame for the user stations. One of these regions is called contention region: all the user stations have equal access thereto. It is thus probable that various user stations simultaneously attempt to have access in the same time slot of the contention region. There is provided that in that case the user stations involved in the contention are to retransmit the corresponding data in another frame. However, no method in this respect is described in the Recommendation.

It is an object of the invention to propose a particularly advantageous contention-solving method.

A TV distribution system according to the invention and as described in the opening paragraph is characterized in that said contention-solving means include configuration means for defining in an upstream frame that follows a contention, contention time slots, and control means for dedicating all the contention time slots to the solution of the contention, so that the user stations involved in this contention retransmit in random fashion in one of these contention time slots the data about which there has been contention.

Similarly, a contention-solving method according to the invention is characterized in that it includes a step for defining contention time slots in an upstream frame that follows a contention, and a step consisting of dedicating all these contention time slots to the solution of the contention, so that the user stations involved in this contention retransmit in random fashion in one of these contention time slots the data about which there has been contention.

A network head-end according to the invention is characterized in that it comprises configuration means for defining in an upstream frame that follows a contention, contention time slots, and control means for dedicating all these contention time slots to the solution of the contention, so that the user stations involved in this contention retransmit in random fashion in one of these contention time slots the data about which there has been contention.

And a user station according to the invention is characterized in that it comprises receiving means for receiving downstream frames transmitted by the network head-end, said downstream frames comprising upstream frame configuration indicators and upstream frame reception indicators, said upstream frame configuration indicators defining the structure of an upstream frame intended to be transported over said channel, and the upstream frame reception indicators indicating the time slot(s) about which there has been contention in an upstream frame previously transported over said channel, analysis means for analyzing said configuration indicators, and analysis means for analyzing said reception indicators to determine its right to transmit in the contention time slots defined by said configuration indicators.

These and other aspects of the invention will be apparent from and elucidated with reference to the embodiments described hereinafter.

In the drawings:

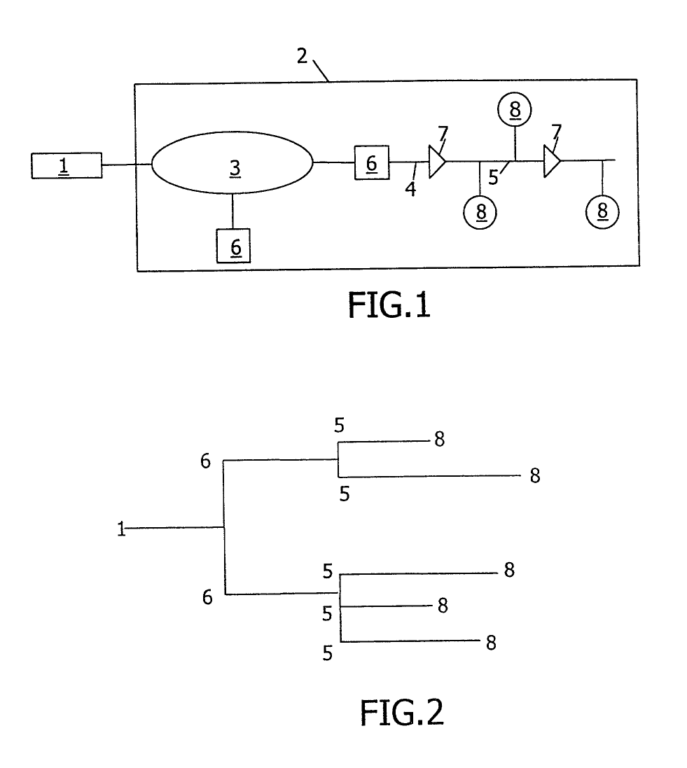

FIG. 1 represents an example of a TV distribution system according to the invention;

FIG. 2 is a diagrammatic representation of the architecture of the system represented in FIG. 1;

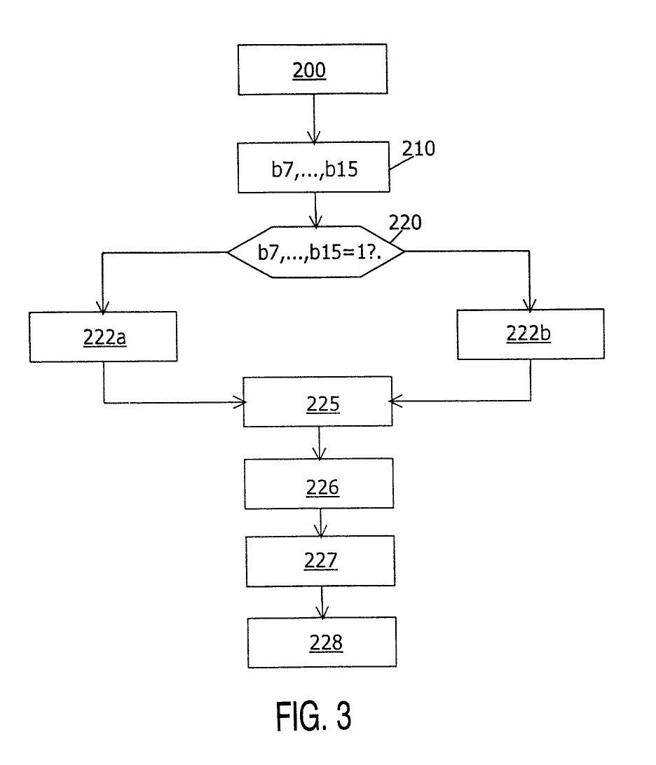

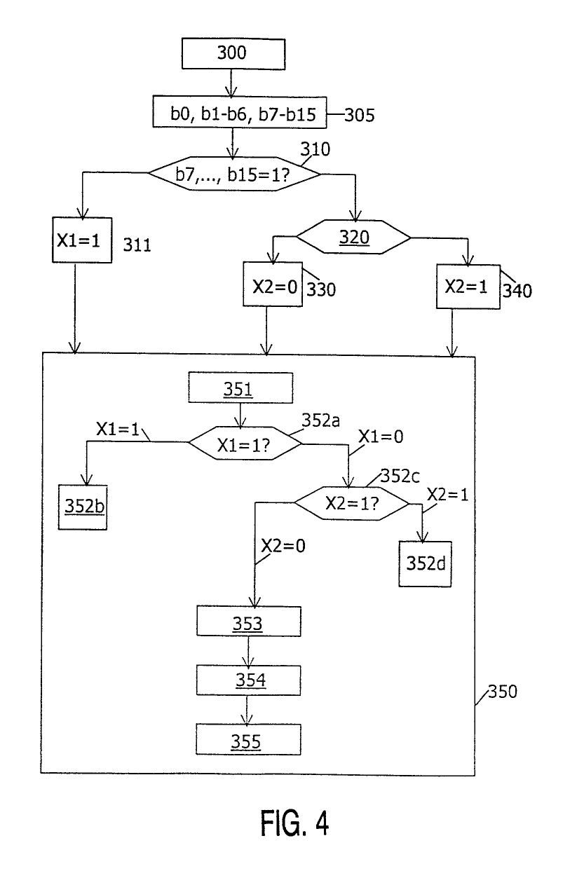

FIGS. 3 and 4 represent an example of a contention-solving method according to the invention;

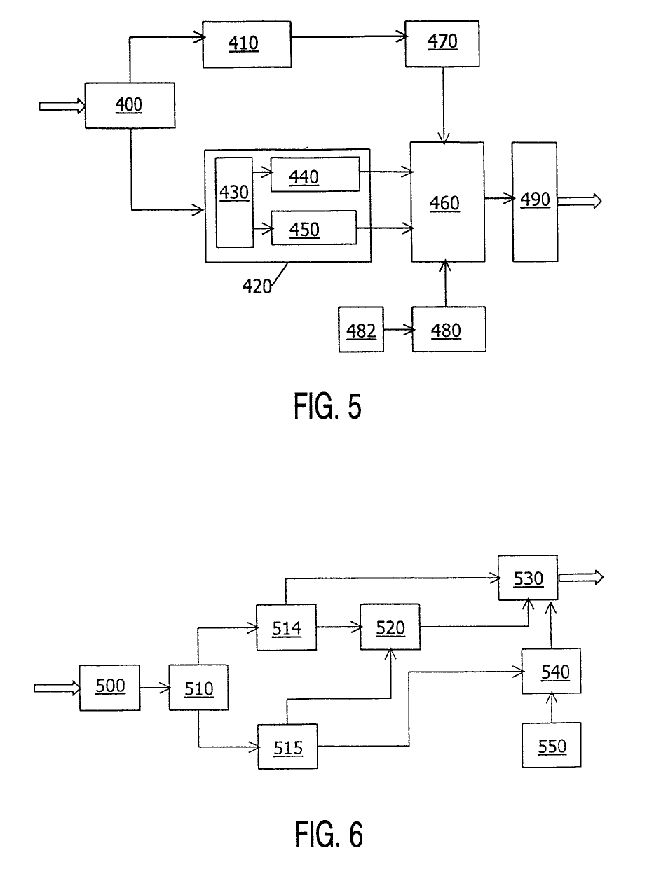

FIG. 5 is a block diagram of an example of a user station according to the invention, and

FIG. 6 is a block diagram of an example of a network head-end according to the invention.

In FIG. 1 is represented an example of a TV distribution system according to the invention. Such a system notably comprises a network head-end 1 connected to a network 2 formed by three sections: a main section 3, a secondary section 4 and a terminal section 5. The main section 3 is made of optical fibers and allows of connecting the network head-end 1 to local nodes 6. The secondary section 4, formed by a coaxial cable, connects each local node 6 to end amplifiers 7. And the terminal section 5, which is also formed by a coaxial cable, connects the end amplifiers 7 to the users 8.

The network 2 has a tree-like architecture which is diagrammatically shown in FIG. 2. The network head-end 1 and the users 8 form the root and the leaves respectively, in this tree-like architecture.

The network 2 has a downstream communication path from the network head-end to the users, and an upstream communication path from the users to the network head-end. These communication paths are in conformity with the specifications defined in Recommendation ETS300800 by ETSI (which takes up the DAVIC standard). Each upstream channel transports frames called upstream frames which are implicit frames: the structure of these frames is defined by the network head-end and transmitted to the users by the downstream path, and the users have a common clock which they use for transmitting data taking into account the structure of the upstream frame transmitted to them by the network head-end.

In conformity with this Recommendation, each downstream channel allows of defining 8 structures of upstream frames intended to be transported over 8 different upstream channels.

Each upstream frame is divided into time slots during which the users can transmit data packets on the physical carrier (in Recommendation ETS300800, one upstream frame is divided into nine time slots). According to this Recommendation (paragraph 5.1.3), various types of time slots can be defined in each upstream frame, notably:

ranging time slots which permit the users to adjust their clock to that of the system,

fixed rate based slots which are reserved for a specific user with a fixed reservation rate (the user has a reservation for one or various time slots in each upstream frame).

reserved time slots which are reserved for a specific user on request (the user sends beforehand a request to be assigned a certain of time slots).

contention time slots which are accessible to all the users. Collisions are thus possible in these contention time slots. They are solved by implementing a contention-solving method.

As indicated in paragraph 5.3.1.3 of the Recommendation, the upstream frames can be subdivided into four regions of variable size which comprise each one type of time slots. This subdivision into four regions is made in the following order: ranging region, contention based region, reserved region, fixed rate based region.

Each downstream frame has the structures of the upstream frames that are to be used for eight upstream channels. One structure is defined for each channel by a bit denoted b0 and called “Ranging Control Slot Indicator” in cited Recommendation, and by a field of 6 bits denoted b1-b6, called “Slot Boundary Definition Field”. The bit b0 indicates whether the upstream frame contains a ranging region. In that case, this ranging region occupies the three first slots of the frame. The field b1-b6 makes it possible to determine the frontiers between each of the three other regions by applying correspondence tables defined in the Recommendation.

And each downstream frame contains reception indicators relating to each of the nine slots of a preceding upstream frame. These indicators denoted b7-b15 indicate whether there has been a collision in the slots concerned. This means that for each transmitted upstream frame, a later downstream frame will indicate the possible collisions that may have happened.

The invention notably has for its object to propose a collision solving method for such a TV distribution system. An example of such a method is represented in FIGS. 3 and 4.

FIG. 3 shows the part of said method that is implemented in the network head-end. In box 200 the network head-end receives an upstream frame. In box 210 it verifies whether one or various collisions have happened and generates the bits b7 to b15 which form the reception indicators relating to this upstream frame. The network head-end will then define a new structure of an upstream frame. For this purpose, the network head-end end tests in box 220 whether one or various collisions have happened (b7, . . . , b15=1?). In that case, it determines in box 222a the size of the contention region of the upstream frame as a function of the number of said collisions. By way of example, 3 contention time slots are defined per collision to be solved (this choice of three time slots gives optimum performance in terms of rapidity of the solving of the contention). If no collision has happened, the network head-end determines the size of the contention region in box 222b as a function of criterions which are independent of the present invention and thus need not be described here. Then, in box 225, the network head-end determines the size of the other regions of the upstream frame as a function of other criterions which are also independent of the present invention. In box 226, the bits b0 and b1 to b6 are generated. In box 227 the network head-end carries out the other conventional processes which are necessary for transmitting the downstream frame. The processing is terminated in box 228 by the transmission of the downstream frame.

FIG. 4 represents the part of the method according to the invention which is implemented in user stations. In box 300, the user station receives a downstream frame coming from the network head-end. In box 305 the user station selects the configuration and reception indicators b0, b1-b6 and b7-b15 which relate to its transmit channel. Then, in box 310, the user station analyzes the reception indicators b7 to b15 to determine whether a contention solution is running (this is the case when at least one of these indicators b7 . . . b15 is active).

If no contention solution is running, the access to the contention region of the upstream frame defined by the bits b0 and b1 to b6 is free, that is to say, that any user station can transmit a data packet in any time slot of this contention region. This free access to the contention region is indicated by the activation of a first binary variable X1 (box 311). The operation is then continued with box 350 where the data packets are transmitted in the upstream frame.

On the other hand, if a contention solution is running, only the stations involved in the contention(s) are authorized to transmit data in this contention region. For this purpose, the station determines in box 320 whether it is involved in the contention by comparing the time slots about which there has been contention and the time slots in which the station had transmitted data in the upstream frame in which the contention has occurred.

If the station is not involved in the contention, it is not authorized to transmit data in the contention region: this is indicated by the deactivation of a second binary variable X2 (box 330).

If the station is involved in the contention, it is to retransmit the data about which there has been contention in one (or various if the station is involved in various collisions) time slot of the contention region chosen in random fashion: this is indicated by the activation of the second binary variable X2 (box 340). The operation is then continued with box 350.

In box 350, the station transmits the data it is to transmit in the upstream frame. For this purpose:

it processes in box 351 the ranging region in a conventional manner;

it processes in box 352 the contention based region in conformity with the contention-solving method according to the invention: in box 352a, it tests the first binary variable X1 to determine whether the access to the contention based region is free. If this is the case, the station transmits in conventional manner to box 352b the data packets it wishes to transmit in the contention based region (they are, for example, requests for being allocated one or various time slots in the reserved region). Then the station carries on this operation in box 353. On the other hand, if the access to the contention based region is not free, the station tests in box 352c the second binary variable X2. If the variable X2 is deactivated, no data is transmitted during the time slots of the contention based region and the operation is carried on with box 353. If the variable X2 is activated, the user station retransmits to box 352d the data about which there has been contention in one or various time slots of the contention based region. Then the operation is proceeded with box 353,

in box 353 the station processes the reserved region in conventional manner,

then in box 354 it processes the fixed rate based region in conventional manner.

The operation is terminated in box 355.

The time slot(s), in which the stations retransmit the data about which there has been contention, have been chosen in random fashion. Consequently, the contention solution itself may give rise to one or various contentions. This contention or these contentions are processed in the same way by applying the method described with reference to FIG. 3. In other words, for solving a contention, the contention-solving method of FIG. 3 is repeated until the network head-end receives an upstream frame without a collision.

In FIG. 5 is represented a block diagram of an example of a user station according to the invention. Such a station notably includes receiving means 400 for receiving downstream frames. Each downstream frame contains reception indicators and configuration indicators relating to eight different upstream channels, and also useful data. The receiving means 400 are thus connected, on the one hand, to means 410 for processing useful data and, on the other hand, to means 420 for processing said indicators. The means 420 for processing the indicators notably comprise indicator selection means 430 which relate to the user station, that is to say, indicators which relate to the transmit channel of this station. These selection means are connected to selected analysis means 440 for analyzing reception indicators and to selected analysis means 450 for analyzing configuration indicators. The analysis means 440 for analyzing reception indicators generate the first and second binary variables X1 and X2 relating to the upstream frame that is to be transmitted, and transmit to access management means 460 which manage the access to the upstream channel. These variables X1 and X2 are used by the access management means 460 for processing the contention based region. Furthermore, the analysis means 450 for analyzing the configuration indicators send the structure of the upstream frame to the access management means 460. The access management means 460 are also connected to storage means 470 for storing reserved time slots and fixed rate time slots which have been assigned to the user station, and to storage means 480 for storing data packets to be transmitted. Storage means 480 are connected to at least a data source 482. Finally, access management means 460 are connected to transmit means 490 for transmitting the upstream frame.

In FIG. 6 is represented a block diagram of an example of a network head-end according to the invention. This network head-end comprises receiving means 500 for receiving upstream frames. These receiving means 500 are connected to processing means 510 for processing time slots contained in each received upstream frame. The processing means 510 are connected, on the one hand, to reception indicator generating means 514 which reception indicators relate to the received upstream frame and, on the other hand, to useful data processing means 515 for processing useful data contained in received time slots. The reception indicators which are generated by the means 514 are intended to be inserted into a following downstream frame.

Besides, management means 520 for managing the assignment of time slots available on the upstream channel generate configuration indicators relating to a following upstream frame. It is in this following upstream frame that the contentions which may occur in the received upstream frame will be solved. These means 520 thus receive the reception indicators generated by the means 514 to determine the size of the contention based region of this following upstream frame. The means 520 also receive certain information coming from the data processing means 515 (for example, information relating to connection requests, to requests for time slot reservation . . . ) so as to be able to determine the size of various regions of this following upstream frame.

The reception indicators and configuration indicators generated by the means 514 and 520 are applied to the means 530 for forming downstream frames, so as to be integrated with the following downstream frame. These means 530 for forming the downstream frame also receive useful data to be transmitted in the downstream frame, coming from storage means 540 for storing data to be transmitted. These means 540 are notably connected to means 550 for receiving data and to means 515 for processing useful data contained in the received upstream frame.

1. A bidirectional TV distribution system of the DAVIC type comprising at least:
a network head-end (1) serving a plurality of user stations (8),
at least an upstream channel (10) for transporting frames called upstream frames from at least certain user stations to the network head-end, said upstream frames, divided into time slots, being suitable for containing time slots called contention time slots which are accessible to any user station in the contention mode for transmitting data to said network head-end,
contention detection means (510) for detecting contentions which are likely to occur during such an access,
contention-solving means for solving said contentions, characterized in that said contention-solving means comprise configuration means (520) for defining in an upstream frame that follows a contention, contention time slots, and control means for dedicating all these contention time slots to the solution of the contention, so that the user stations involved in this contention retransmit in random fashion in one of these contention time slots the data about which there has been contention.

2. A bidirectional TV distribution system as claimed in claim 1, characterized in that
said network head-end comprises receiving means (500) for receiving upstream frames, contention detection means (510) for detecting contention in said received upstream frames, means (514) for generating reception indicators (b7-b15) relating to a received upstream frame to indicate the time slot(s) of this received upstream frame for which there has been contention, means (520) for generating configuration indicators (b0, b1-b6) to define the structure of a following upstream frame, so that, when one or various contentions have been detected in said received upstream frame, contention time slots dedicated to the solution of said contentions are defined in said following upstream frame, and transmit means (530) for transmitting a downstream frame containing said configuration and reception indicators,
and said user stations comprise analysis means (440 or 450) for analyzing said reception and configuration indicators to determine their right to transmit in the contention time slots defined by said configuration indicators.

3. A bidirectional TV distribution system as claimed in claim 2, characterized in that a station's right to transmit is determined in the following manner:
if no contention has taken place, the station has the right to transmit freely data in the contention time slots,
if one or various contentions have taken place in which the station is not involved, the station does not have the right to transmit data in the contention time slots,
if one or various contentions have taken place in which the station is involved, the station has to retransmit for each contention it is involved in, the data affected by this contention in a randomly chosen contention time slot.

4. A contention-solving method intended to be used in a bidirectional TV distribution system of the DAVIC type comprising a network head-end (1) serving a plurality of user stations (8) and at least an upstream channel (10) for transporting frames called upstream frames from at least certain user stations to the network head-end, said upstream frames being subdivided into time slots and being suitable for containing time slots called contention time slots which are accessible to any user station in the contention mode for transmitting data to said network head-end, characterized in that the method includes a step (222a) for defining contention time slots in an upstream frame that follows a contention, and a step (320, 330, 340 and 352) consisting of dedicating all these contention time slots to the solution of the contention, so that the user stations involved in this contention retransmit in random fashion in one of these contention time slots the data about which there has been contention.

5. A contention-solving method as claimed in claim 4, characterized in that it includes:
a step (210) for detecting contentions in the received upstream frames and, when one or various contentions are detected in a received upstream frame:
a step (228) for transmitting a downstream frame containing configuration indicators which define contention time slots dedicated to the solution of said contentions in an upstream frame intended to be transported over said channel, and reception indicators which indicate the time slot(s) of said received upstream frame for which there has been contention,
and an analysis step (310), by the user stations which receive said downstream frame, for analyzing said reception and configuration indicators to determine their right to transmit in the contention time slots defined by said configuration indicators.

6. A contention-solving method as claimed in claim 5, characterized in that said right to transmit is determined in the following fashion:
if there has not been any contention, the station has the right to transmit freely data in the contention time slots,
if there have been one or various contentions in which the station is not involved, the station does not have the right to transmit data in the contention time slots,
if there have been one or various contentions in which the station is involved, the station is to retransmit for each contention in which it is involved the data affected by this contention in a randomly chosen contention time slot.

7. A network head-end (1) intended to be used in a bidirectional TV distribution system of the DAVIC type for serving a plurality of user stations (8), said system comprising at least:
an upstream channel (10) for transporting upstream frames from at least certain user stations to the network head-end, said upstream frames, divided into time slots, being suitable for containing time slots called contention time slots which are accessible to any user station in the contention mode for transmitting data to said network head-end,
contention detection means (510) for detecting contentions which are likely to occur during such access,
contention-solving means for solving said contentions, characterized in that the network head-end comprises: configuration means (520) for defining in an upstream frame that follows a contention, contention time slots, and control means (440, 450, 460) for dedicating all these contention time slots to the solution of the contention, so that the user stations involved in this contention retransmit in random fashion in one of these contention time slots the data about which there has been contention.

8. A network head-end as claimed in claim 7, characterized in that it comprises:
receiving means (500) for receiving upstream frames,
contention detection means (510) for detecting contention in said upstream frames,
generating means (514) for generating reception indicators (b7-b15) relating to an upstream frame received to indicate the time slot(s) for which there has been contention,
generating means (520) for generating configuration indicators (b0, b1-b6) to define the structure of a following upstream frame, so that, when one or various contentions have been detected in said received upstream frame, contention time slots dedicated to the solution of said contentions are defined in said following upstream frame,
and transmit means (530) for transmitting a downstream frame containing said configuration and reception indicators.

9. A user station (8) intended to be served by a network head-end (1) of a TV distribution system of the DAVIC type which comprises at least:
an upstream channel for transporting upstream frames from at least certain user stations to the network head-end, said upstream frames, divided into time slots, being suitable for containing time slots called contention time slots which are accessible to any user station in the contention mode for transmitting data to said network head-end,
contention detection means for detecting contentions which are likely to occur during such access,
contention-solving means for solving said contentions, characterized in that it comprises:
receiving means (400) for receiving downstream frames transmitted by the network head-end, said downstream frames including configuration indicators (b0, b1-b6) of an upstream frame and reception indicators (b7-b15) of an upstream frame, said configuration indicators of an upstream frame defining the structure of an upstream frame intended to be transported over said upstream channel, and the reception indicators of an upstream frame indicating the time slot(s) about which there has been contention in an upstream frame previously transported by said upstream channel,
analysis means (450) for analyzing said configuration indicators,
and analysis means (440) for analyzing said reception indicators for determining its right to transmit in the contention time slots defined by said configuration indicators.

10. A user station as claimed in claim 9, characterized in that it comprises means (460) for determining its right to transmit in said contention time slots as a function of the following criterions:
if there has not been any contention, the station has the right to transmit freely data in the contention time slots,
if one or various contentions have taken place in which the station is not involved, the station does not have the right to transmit data in the contention time slots,
if one or various contentions have taken place in which the station is involved, the station has to retransmit for each contention in which it is involved the data affected by this contention in a randomly chosen contention time slot.
